(19) United States
(12) Patent Application Publication
(10) Pub. No.: US 2026/0255019 A1
(43) Pub. Date: Aug. 27, 2026

(54) IMAGE DISPLAY DEVICE AND OPERATING METHOD THEREOF

(71) Applicant: LG ELECTRONICS INC., Seoul (KR)

(72) Inventors: Yookyoung CHOI, Seoul (KR); Jaekyung LEE, Seoul (KR); Hyangjin LEE, Seoul (KR); Jeean CHANG, Seoul (KR); Myeongok SON, Seoul (KR); Yeongbin BYEON, Seoul (KR)

(73) Assignee: LG ELECTRONICS INC., Seoul (KR)

(21) Appl. No.: 18/857,170

(22) PCT Filed: Apr. 15, 2022
(86) PCT No.: PCT/KR2022/005489

§ 371 Date: Oct. 15, 2024

(51) Int. Cl. H04N 21/45; H04N 21/422

(52) U.S. Cl. CPC H04N 21/4532; H04N 21/42203

(57) ABSTRACT

The present invention relates to an image display device and an operating method thereof. The image display device according to an embodiment of the present invention comprises: a display; a network interface unit for performing communication with at least one server; a memory for storing at least one database corresponding to an application; and a control unit, wherein the control unit determines, on the basis of reception of a predetermined input related to a specific application, at least one piece of data corresponding to a timepoint when the predetermined input is received from among pieces of data included in a database corresponding to the specific application, transmits, on the basis of the determined at least one piece of data, a first keyword corresponding to the specific application to a server through the network interface unit, and outputs, on the basis of reception of at least one second keyword associated with the first keyword from the server through the network interface unit, a screen including at least one recommended keyword corresponding to the received second keyword through the display. Various other embodiments are possible.

### TECHNICAL FIELD

The present disclosure relates to an image display device and a method of operating the image display device.

### BACKGROUND ART

An image display device is a device having a function of displaying an image that can be viewed by a user, and the user can watch broadcast content via the image display device. Examples of the image display device may include a television (TV), a monitor, and a projector equipped with a liquid crystal display (LCD) using a liquid crystal or an organic light-emitting diode (OLED) display using an OLED.

Recently, digital TV services using wired or wireless communication networks have become more common. The digital TV services provide various services that cannot be provided by existing analog broadcasting services.

Conventionally, a content provider (CP) recommends the latest content or popular content that is most viewed by other users, or web content related to TV broadcast content currently being watched by a user. However, content recommended through the conventional method is often different from the user's preference.

An external server may collect user's usage history on an image display device and recommend content or keywords to a user based on the usage history collected by the external server. However, this usually requires a user's consent to provide personal information. If the user does not consent to the provision of personal information for reasons such as concerns about personal information leakage, content that matches the user's preference is not recommended at all.

In addition, an image display device may internally collect user's usage history and recommend content or keywords to a user based on the usage history. However, when there are a plurality of applications installed on the image display device to output content, it may be difficult to recommend content or keywords optimized for each application.

### DISCLOSURE

### Technical Problem

It is an objective of the present disclosure to solve the above and other problems.

It is another objective of present disclosure is to provide an image display device that can recommend keywords for content that a user is likely to prefer in a faster and more accurate manner based on the user's usage history, without worrying about personal information leakage, and a method of operating the same.

It is yet another objective of present disclosure is to provide an image display device that can recommend optimized keywords for each of a plurality of applications, and a method of operating the same.

### Technical Solution

According to an aspect of the subject matter described in this application, an image display device includes: a display; a network interface configured to communicate with at least one server; a memory configured to store at least one database corresponding to an application; and a controller, wherein the controller is configured to: in response to receiving a predetermined input associated with a specific application, determine, of data included in a database corresponding to the specific application, at least one piece of data corresponding to a time at which the predetermined input is received; based on the determined at least one piece of data, transmit a first keyword corresponding to the specific application to a server through the network interface; and based on at least one second keyword related to the first keyword being received from the sever through the network interface, output, via the display, a screen including at least one recommended keyword corresponding to the received second keyword.

In one implementation, the image display device may further include a microphone. The controller may be configured to: in response to receiving speech of a user through the microphone, determine an application corresponding to the received speech; and add data corresponding to the speech to a database corresponding to the determined application. The data corresponding to the speech may include at least one of an input keyword corresponding to a word included in the speech and a related keyword related to the input keyword, and a time at which the speech is received.

In one implementation, the input keyword may include a word corresponding to a target of an operation among words included in the speech, and the related keyword may include a type of the target.

In one implementation, the controller may be configured to: based on a specific word corresponding to an application being included in the speech, determine an application corresponding to the specific word as an application corresponding to the speech; and based on a specific word corresponding to an application not being included in the speech, determine an application that is being executed at a time when the speech is received as an application corresponding to the speech.

In one implementation, the controller may be configured to determine the first keyword based on a frequency of keywords included in the at least one piece of data corresponding to the time at which the predetermined input is received.

In one implementation, the first keyword may include a first word corresponding to a search target, and the second keyword may include at least one second word related to the first word. The controller may be configured to determine the first word and the second word as one recommended keyword.

In one implementation, the first keyword may include a specific type of content, and the second keyword may include at least one word that corresponds to specific content corresponding to the specific type. The controller may be configured to determine a word corresponding to the specific content as the recommended keyword.

According to another aspect, there is provided a method of operating an image display device, the method including: in response to receiving a predetermined input associated with a specific application, determining, of data included in a database corresponding to the specific application stored in a memory, at least one piece of data corresponding to a time at which the predetermined input is received; based on the determined at least one piece of data, transmitting a first keyword corresponding to the specific application to a server; and based on at least one second keyword related to the first keyword being received from the server, outputting, via a display, a screen including at least one recommended keyword corresponding to the received second keyword.

In one implementation, the method may further include: in response to receiving speech of a user through a microphone, determining an application corresponding to the received speech; and adding data corresponding to the speech to a database corresponding to the determined application. The data corresponding to the speech may include at least one of an input keyword corresponding to a word included in the speech and a related keyword related to the input keyword, and a time at which the speech is received.

In one implementation, the input keyword may include a word corresponding to a target of an operation among words included in the speech, and the related keyword may include a type of the target.

In one implementation, the method may further include: based on a specific word corresponding to an application being included in the speech, determining an application corresponding to the specific word as an application corresponding to the speech; and based on a specific word corresponding to an application not being included in the speech, determining an application that is being executed at a time when the speech is received as an application corresponding to the speech.

In one implementation, the transmitting of the first keyword to the server may include determining the first keyword based on a frequency of keywords included in the at least one piece of data corresponding to the time at which the predetermined input is received.

In one implementation, the first keyword may include a first word corresponding to a search target, and the second keyword may include at least one second word related to the first word. The outputting of the screen may include determining the first word and the second word as one recommended keyword.

In one implementation, the first keyword may include a specific type of content, and the second keyword may include at least one word that corresponds to specific content corresponding to the specific type. The outputting of the screen may include determining a word corresponding to the specific content as the recommended keyword.

### Advantageous Effects

An image display device and a method of operating the same have the following effects.

According to various embodiment of the present disclosure, keywords for content that a user is likely to prefer can be recommended more quickly and accurately based on the user's usage history, without worrying about personal information leakage.

According to various embodiment of the present disclosure, optimized keywords can be recommended for each of a plurality of applications.

Further scope of applicability of the present disclosure will become apparent from the detailed description given hereinafter. It should be understood, however, that the detailed description and specific examples, such as the preferred embodiments of the present disclosure, are given by way of illustration only, since various changes and modifications within the spirit and scope of the present disclosure will be apparent to those skilled in the art.

### BRIEF DESCRIPTION OF DRAWINGS

FIG. 1 illustrates an image display system according to an embodiment of the present disclosure.

FIG. 2 is an internal block diagram of an image display device of FIG. 1.

FIG. 3 is an internal block diagram of a controller of FIG. 2.

FIG. 4 illustrates a control method of a remote control device of FIG. 2.

FIG. 5 is an internal block diagram of a remote control device of FIG. 2.

FIGS. 6A and 6B are flowcharts illustrating a method of operating an image display device according to an embodiment of the present disclosure.

FIGS. 7 to 15 are diagrams for explaining a method of operating an image display device.

### MODE FOR THE INVENTION

Hereinafter, the present disclosure will be described in detail with reference to the accompanying drawings. In order to clearly and briefly describe the present disclosure, components that are irrelevant to the description will be omitted in the drawings. The same reference numerals are used throughout the drawings to designate the same or similar components.

The suffixes “module” and “unit” used in the following description are given simply in view of the ease of the description, and do not carry any important meaning or role. Therefore, the “module” and the “unit” may be used interchangeably.

It will be understood that the terms “comprises or includes,” “has,” etc., when used in this specification, specify the presence of stated features, integers, steps, operations, elements, components, or combinations thereof, but do not preclude the presence or addition of one or more other features, integers, steps, operations, elements, components, or combinations thereof.

It will be further understood that although the terms “first,” “second,” etc. are used herein to describe various components, these components should not be limited by these terms. These terms are only used to distinguish one component from another component.

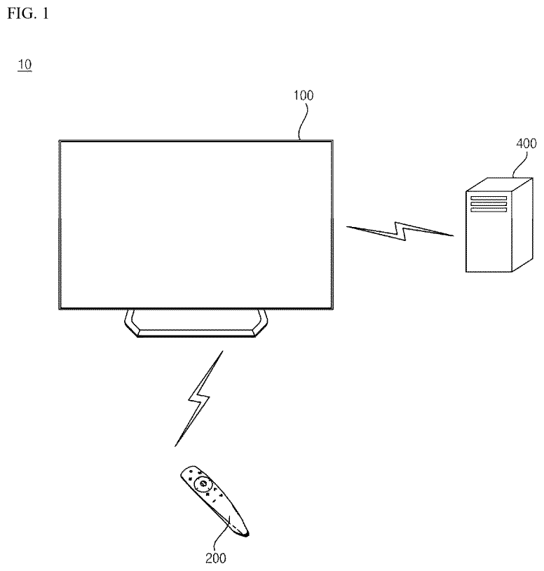

FIG. 1 illustrates an exemplary image display system according to embodiments of the present disclosure.

Referring to FIG. 1, an image display system 10 may include an image display device 100 and/or a remote control device 200.

The image display device 100 may be a device that processes and outputs an image. The image display device 100 may be a TV, a notebook computer, a monitor, or the like, and is not particularly limited as long as it can output a screen corresponding to an image signal.

The image display device 100 may receive a broadcast signal, process the received broadcast signal, and output a signal-processed broadcast image. When the image display device 100 is configured to receive a broadcast signal, the image display device 100 may correspond to a broadcast reception device.

The image display device 100 may receive a broadcast signal wirelessly via an antenna, or may receive a broadcast signal in a wired manner via a cable. For example, the image display device 100 may receive a terrestrial broadcast signal, a satellite broadcast signal, a cable broadcast signal, an Internet Protocol Television (IPTV) broadcast signal, etc.

The remote control device 200 may be connected, wired and/or wirelessly, to the image display device, thereby providing various control signals to the image display device 100. In this case, the remote control device 200 may include a device that establishes a wired or wireless network with the image display device 100 to transmit, through the established network, various control signals to the image display device 100 or receive, through the established network, signals associated with various operations processed by the image display device 100 from the image display device 100.

For example, various input devices such as a mouse, a keyboard, a spatial remote controller, a trackball, a joystick, and the like may be used as the remote control device 200. The remote control device 200 may be referred to as an external device, and the external device and the remote control device may be used interchangeably in the following description, as necessary.

The image display device 100 may be connected to only a single remote control device 200, or may be simultaneously connected to two or more remote control devices to change an object displayed on a screen or adjust a screen status based on control signals provided by the respective remote control devices 200.

Meanwhile, the image display system 10 may further include at least one server 400. The image display device 100 may transmit and receive data to and from the server 400. For example, the image display device 100 may transmit and receive data to and from the server over a network such as Internet.

The image display device 100 may transmit data regarding an operation performed according to a user input, and the server 400 may store the data received from the image display device 100.

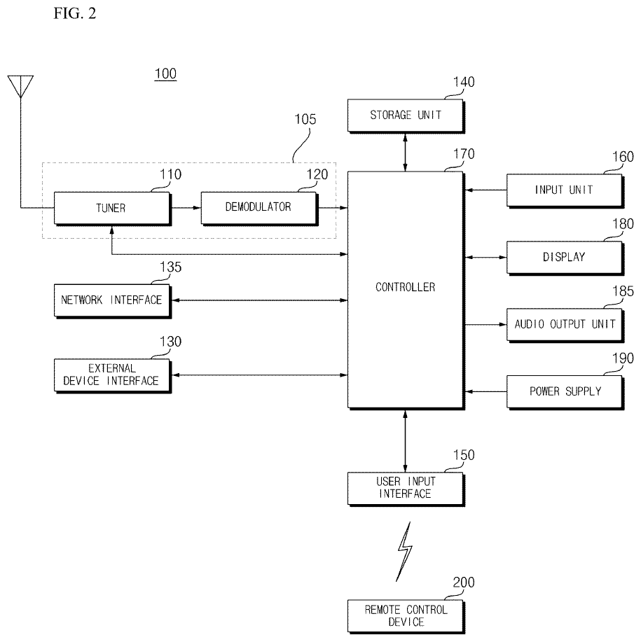

FIG. 2 is an internal block diagram of an image display device of FIG. 1.

Referring to FIG. 2, the image display device 100 may include a broadcast receiver 105, an external device interface 130, a network interface 135, a storage unit 140, a user input interface 150, an input unit 160, a controller 170, a display 180, an audio output unit 185, and/or a power supply 190.

The broadcast receiver 105 may include a tuner 110 and a demodulator 120.

Meanwhile, unlike the drawing, the image display device 100 may include only the broadcast receiver 105 and the external device interface 130, among the broadcast receiver 105, the external device interface 130, and the network interface 135. That is, the image display device 100 may not include the network interface 135.

The tuner 110 may select a broadcast signal corresponding to a channel selected by a user or each of all prestored channels from among broadcast signals received through an antenna (not shown) or a cable (not shown). The tuner 110 may covert the selected broadcast signal into an intermediate frequency (IF) signal or a baseband video or audio signal.

For example, when the selected broadcast signal is a digital broadcast signal, the tuner 110 may convert it into a digital IF signal (DIF), and when the selected broadcast signal is an analog broadcast signal, the tuner 110 may convert it into an analog baseband video or audio signal (CVBS/SIF). That is, the tuner 110 may may process a digital broadcast signal or an analog broadcast signal. The analog baseband video or audio signal (CVBS/SIF) output from the tuner 110 may be directly input to the controller 170.

The tuner 110 may sequentially select broadcast signals corresponding to all broadcast channels stored through a channel memory function from among the received broadcast signals, and may convert the selected broadcast signals into IF signals or baseband video or audio signals.

The tuner 110 may be implemented as plurality of tuners so as to receive broadcast signals of a plurality of channels. Alternatively, the tuner 110 may be implemented as a signal tuner capable of simultaneously receiving broadcast signals of a plurality of channels.

The demodulator 120 may receive a digital IF signal (DIF) converted by the tuner 110 to demodulate the digital IF signal (DIF).

The demodulator 120 may perform demodulation and channel decoding and then may output a stream signal (TS). Here, the steam signal may be a multiplexed video signal, audio signal or data signal.

The stream signal output from the demodulator 120 may be input to the controller 170. The controller 170 may perform demultiplexing and video/audio signal processing, and then may output an image and sound through the display 180 and the audio output unit 185, respectively.

The external device interface 130 may transmit or receive data to or from an external device connected thereto. To this end, the external device interface 130 may include an A/V input and output unit (not shown).

The external device interface 130 may be connected, wired or wirelessly, to an external device such as a digital versatile disc (DVD) player, a Blu-ray player, a game console, a camera, a camcorder, a computer (e.g., a laptop or notebook), a set-top box, or the like, and may perform input/output operation with the external device.

In addition, the external device interface 130 may establish a communication network with various remote control devices 200 similar to as shown in FIG. 1, so as to receive control signals associated with the operation of the image display device 100 from the remote control devices 200 or to transmit data regarding the operation of the image display device 100 to the remote control devices 200.

The A/V input and output unit may receive video and audio signals from the external device. For example, the A/V input and output unit may include an Ethernet terminal, a USB terminal, a CVBS (Composite Video Banking Sync) terminal, a component terminal, an S-video terminal (analog), a DVI (Digital Visual Interface) terminal, a HDMI (High-Definition Multimedia Interface) terminal, an MHL (Mobile High-definition Link) terminal, a RGB terminal, a D-SUB terminal, an IEEE 1394 terminal, an SPDIF terminal, a liquid HD terminal, etc. Digital signals input through these terminals may be transmitted to the controller 170. In this case, analog signals input through the CVBS terminal and the S-video terminal may be converted into digital signals by an analog-digital converter (not shown) to be transmitted to the controller 170.

The external device interface 130 may include a wireless communication unit (not shown) for short-range communication with other electronic devices. The wireless communication unit may allow the external device interface 130 to exchange data with a mobile terminal nearby. For example, the external device interface 130 may receive, from the mobile terminal, device information, information about an application that is being executed, an application image, and the like in a mirroring mode.

The external device interface 130 may perform short-range wireless communication using Bluetooth, Radio Frequency Identification (RFID), Infrared Data Association (IrDA), Ultra-Wideband (UWB), ZigBee, or the like.

The network interface 135 may provide an interface for connecting the image display device 100 to wired/wireless networks including an Internet network.

The network interface 135 may include a communication module (not shown) to communicate with a wired/wireless network. For example, the network interface 135 may include a communication module for Wireless LAN (WLAN) (Wi-Fi), Wireless Broadband (WiBro), Worldwide Interoperability for Microwave Access (WiMAX), High Speed Downlink Packet Access (HSDPA), or the like.

The network interface 135 may transmit or receive data with another user or another electronic device over a connected network or another network linked to the connected network.

The network interface 135 may receive web content or data provided by a content provider or a network operator. That is, the network interface 135 may receive, through a network, content, such as movies, advertisements, games, VODs and broadcasts, and information related the content provided by a content provider or a network operator.

The network interface 135 may receive update information and update files of firmware provided by a network operator, and may transmit data over the Internet or to a content provider or a network provider.

The network interface 135 may select and receive, through a network, a desired application from among applications open to the public.

The storage unit 140 may store a program for processing and controlling each signal in the controller 170 or may store a signal-processed video (or image), audio, or data signal. For example, the storage unit 140 may store application programs designed to perform various tasks that can be processed by the controller 170, and may selectively provide some of the stored application programs upon request by the controller 170.

The program or the like stored in the storage unit 140 is not particularly limited as long as it can be executed by the controller 170.

The storage unit 140 may perform a function of temporarily storing a video, audio, or data signal received from an external device through the external device interface 130.

The storage unit 140 may store information on predetermined broadcast channels through a channel memory function such as channel map, or the like.

Although FIG. 2 illustrates an example in which the storage unit 140 is provided separately from the controller 170, the scope of the present disclosure is not limited thereto, and the storage unit 140 may be included in the controller 170.

The storage unit 140 may include at least one of volatile memory (e.g., DRAM, SRAM, SDRAM, etc.) or non-volatile memory (e.g., flash memory, hard disk drive (HDD), solid-state drive (SSD), etc.). In various embodiments of the present disclosure, the storage unit 140 and the memory may be used interchangeably.

The user input interface 150 may deliver a signal input by a user to the controller 170 or may deliver a signal from the controller 170 to the user.

For example, the user input interface 150 may transmit/receive a user input signal such as power on/off, channel selection, or screen setting to/from the remote control device 200, may transmit a user input signal input through a local key (not shown) such as a power key, a channel key, a volume key, or a setting key to the controller 170, may transmit a user input signal input from a sensor unit (not shown) that senses a user's gesture to the controller 170, or may transmit a signal from the controller 170 to the sensor unit.

The input unit 160 may be provided on one side of a body of the image display device 100. For example, the input unit 160 may include a touch pad, a physical button, etc.

The input unit 160 may receive various user commands related to the operation of the image display device 100, and may transmit a control signal corresponding to the received command to the controller 170.

The input unit 160 may include at least one microphone (not shown), and may receive a user's voice or speech through the microphone.

The controller 170 may include at least one processor, and may control the overall operation of the image display device 100 using the processor included therein. Here, the processor may be a general processor such as a central processing unit (CPU). Alternatively, the processor may be a dedicated device such as an application-specific integrated circuit (ASIC), or any of other hardware-based processors.

The controller 170 may demultiplex a stream input through the tuner 110, the demodulator 120, the external device interface 130, or the network interface 135, or may process demultiplexed signals to generate and output a signal for image or audio output.

The display 180 may convert an image (or video) signal, a data signal, an on-screen display (OSD) signal or a control signal processed by the controller 170, or an image (or video) signal, a data signal or a control signal received from the external device interface 130 to generate a driving signal.

The display 100 may include a display panel (not shown) including a plurality of pixels.

The plurality of pixels provided in the display panel may include RGB subpixels. Alternatively, the plurality of pixels provided in the display panel may include RGBW subpixels. The display 180 may convert an image signal, a data signal, an OSD signal or a control signal processed by the controller 170 to generate a signal for driving the plurality of pixels.

The display 180 may be a plasma display panel (PDP) display, a liquid crystal display (LCD), an organic light-emitting diode (OLED) display, a flexible display, or the like. Alternatively, the display 180 may be a three-dimensional (3D) display. The 3D display 180 may be classified as a non-glasses type and a glasses type.

Meanwhile, the display 180 may be configured as a touch screen and thus may be used not only as an output device but also as an input device.

The audio output unit 185 may receive an audio signal processed by the controller 170 to output sound.

The image signal processed by the controller 170 may be input to the display 180, allowing an image corresponding to the received image signal to be displayed. In addition, the image signal processed by the controller 170 may be input to an external output device through the external device interface 130.

The audio signal processed by the controller 170 may be output in the form of sound through the audio output unit 185. In addition, the audio signal processed by the controller 170 may be input to the external output device through the external device interface 130.

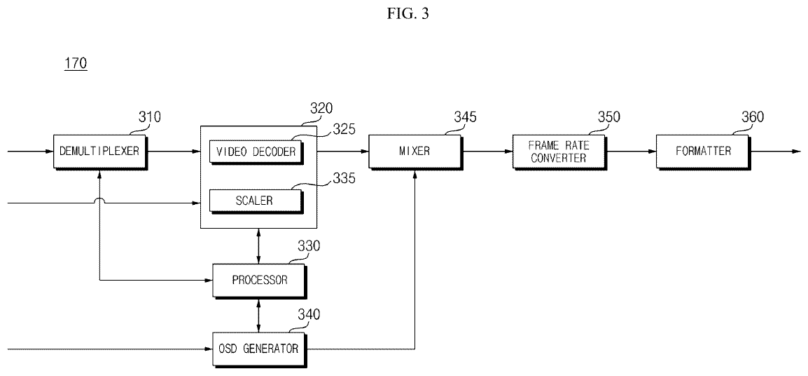

Although it is not illustrated in FIG. 2, the controller 170 may include a demultiplexer, an image processing unit, etc. This will be described with reference to FIG. 3.

The controller 170 may control the overall operation of the image display device 100. For example, the controller 170 may control the tuner 110 to tune a broadcast signal corresponding to a channel selected by a user or a prestored channel.

In addition, the controller 170 may control the image display device 100 in response to a command input by the user through the user input interface 150 or according to an internal program.

The controller 170 may control the display 180 to display an image. Here, the image displayed on the display 180 may be a still image or a video, and may be a 2D image or a 3D image.

The controller 170 may control such that a predetermined 2D object is displayed in the image displayed on the display 180. For example, the object may be at least one of a connected web screen (e.g., newspaper or magazine), an electronic program guide (EPG), various menus, a widget, an icon, a still image, a video, and a text.

Meanwhile, the image display device 100 may further include a photographing unit (not shown). The photographing unit may photograph a user. The photographing unit may be configured as a single camera, but is not limited thereto, and may be configured as a plurality of cameras. The photographing unit may be embedded in the image display device 100, namely, at an upper portion of the display 180 or may be provided separately. Information of an image captured by the photographing unit may be input to the controller 170.

The controller 170 may recognize the location of a user based on an image captured by the photographing unit. For example, the controller 170 may identify a distance (z-axis coordinate) between the user and the image display device 100. In addition, the controller 170 may determine the x-axis coordinate and the y-axis coordinate in the display 180 that correspond to the location of the user.

The controller 170 may detect a user's gesture based on an image captured by the photographing unit, or each of signals sensed by the sensor unit or a combination thereof.

The power supply 190 may supply corresponding power throughout the image display device 100. In particular, the power supply 190 may supply power to the controller 170, which can be implemented as a system-on-chip (SOC), the display 180 for displaying an image, and the audio output unit 185 for audio output.

Specifically, the power supply 190 may include a converter (not shown) for converting alternating-current (AC) power to direct-current (DC) power, and a DC/DC converter (not shown) for converting the level of DC power.

The remote control device 200 may transmit a user input to the user input interface 150. To this end, the remote control device 200 may use Bluetooth, Radio Frequency (RF) communication, Infrared Radiation (IR) communication, Ultra-Wideband (UWB), ZigBee, or the like. In addition, the remote control device 200 may receive a video, audio, or data signal output from the user input interface 150 to output the received signal in the form of an image or sound.

The image display device 100 described above may be a digital broadcast receiver capable of receiving a fixed or mobile digital broadcast.

Meanwhile, the block diagram of the display device 100 shown in FIG. 2 is merely one embodiment of the present disclosure, and the respective components of the display device 100 may be combined, added, or omitted according to the specification of the image display device 100 that is actually implemented.

In other words, as necessary, two or more components may be combined into one component, or one component may be subdivided into two or more components. In addition, the function performed in each block is merely illustrative, and a specific operation or configuration thereof does not limit the scope of the present disclosure.

FIG. 3 is an internal block diagram of a controller of FIG. 2.

Referring to FIG. 3, the controller 170 according to an embodiment of the present disclosure may include a demultiplexer 310, an image processing unit 320, a processor 330, an OSD generator 340, a mixer 345, a frame rate converter 350, and/or a formatter 360. The controller 170 may further include an audio processing unit (not shown) and a data processing unit (not shown).

The demultiplexer 310 may demultiplex an input stream. For example, the demultiplexer 310 may demultiplex an MPEG-2 TS into an image (or video) signal, an audio signal, and a data signal. Here, the stream signal input to the demultiplexer 310 may be a stream signal output from the tuner 110, the demodulator 120, or the external device interface 130.

The image processing unit 320 may process the demultiplexed image signal. To this end, the image processing unit 320 may include a video decoder 325 and a scaler 335.

The video decoder 325 may decode the demultiplexed image signal, and the scaler 335 may perform scaling to allow the resolution of the decoded image signal to be displayed on the display 180.

The video decoder 325 may include decoders of various standards. For example, the video decoder 325 may include an MPEG-2 decoder, an H.264 decoder, a 3D video decoder for a color image and a depth image, a decoder for multi-view images, etc.

The processor 330 may control the overall operation of the image display device 100 or the controller 170. For example, the processor 330 may control the tuner 110 to tune a broadcast corresponding to a channel selected by a user or a prestored channel.

Additionally, the processor 330 may control the image display device 100 according to a user command input through the user input inface 150 or according to an internal program.

Additionally, the processor 330 may control data transmission with the network interface 135 or the external device interface 130.

Additionally, the processor 330 may control the operation of the demultiplexer 310, the image processing unit 320, the OSD generator 340, and the like in the controller 170.

The OSD generator 340 may generate an OSD signal autonomously or according to a user input. For example, based on a user input signal input through the input unit 160, the OSD generator 340 may generate a signal for displaying various kinds of information as a graphic or text on the screen of the display 180.

The generated OSD signal may include various data such as a user interface screen of the image display device 100, various menu screens, widgets, icons, and the like. In addition, the generated OSD signal may include a 2D object or a 3D object.

The OSD generator 340 may generate a pointer that can be displayed on the display 180 based on a pointing signal received from the remote control device 200.

The OSD generator 340 may include a pointing signal processor (not shown) to generate a pointer. The pointing signal processor (not shown) may be provided separately, instead of being provided in the OSD generator 340.

The mixer 345 may mix the OSD signal generated by the OSD generator 340 and the decoded image signal processed by the image processing unit 320. The mixed image signal may be provided to the frame rate converter 350.

The frame rate converter (FRC) 350 may convert the frame rate of an input image. Alternatively, the frame rate converter 350 may output an input image without any frame rate conversion.

The formatter 360 may arrange a left-eye image frame and a right-eye image frame of the frame rate converted 3D image. The formatter 360 may output a synchronization signal Vsync to open the left eye glass and the right eye glass of a 3D viewing device (not shown).

Meanwhile, the formatter 360 may change the format of an input image signal to an image signal suitable for being displayed on the display 180.

In addition, the formatter 360 may change the format of a 3D image signal. For example, the formatter 360 may change the format of a 3D image signal to one of various 3D formats such as a side-by-side format, a top/down format, a frame sequential format, an interlaced format, and a checker box format.

Meanwhile, the formatter 360 may convert a 2D image signal into a 3D image signal. For example, according to a 3D image generation algorithm, the formatter 360 may detect an edge or a selectable object in a 2D image signal, and separate and generate an object according to the detected edge or the selectable object as a 3D image signal. Here, the generated 3D image signal may be separated into a left-eye image signal L and a right-eye image signal R to be aligned.

Although not shown in the drawing, a 3D processor (not shown) for 3-dimensional (3D) effect signal processing may be further provided after the formatter 360. Such a 3D processor may perform brightness, tint, and color adjustment to improve 3D effects. For example, the 3D processor may perform signal processing to make the near clear and the far blurry. Meanwhile, the function of the 3D processor may be integrated into the formatter 360 or the image processing unit 320.

Meanwhile, the audio processing unit (not shown) in the controller 170 may process a demultiplexed audio signal. To this end, the audio processing unit (not shown) may include various decoders.

The audio processing unit (not shown) in the controller 170 may perform bass, treble, and volume adjustment.

The data processing unit (not shown) in the controller 170 may perform data processing on a demultiplexed data signal. For example, when the demultiplexed data signal is an encoded data signal, the data processing unit may decode it. The encoded data signal may be electronic program guide (EPG) information including broadcasting information such as the start time and end time of broadcast programs aired on each channel.

Meanwhile, the block diagram of the controller 170 shown in FIG. 3 is merely one example of the present disclosure. The respective components of the block diagram may be combined, added, or omitted depending on the specification of the controller 170 that is actually implemented.

In particular, the frame rate converter 350 and the formatter 360 may not be provided in the controller 170. Instead, the frame rate converter 350 and the formatter 360 may be respectively provided separately from the controller 170 or may be provided as a single module separately from the controller 170.

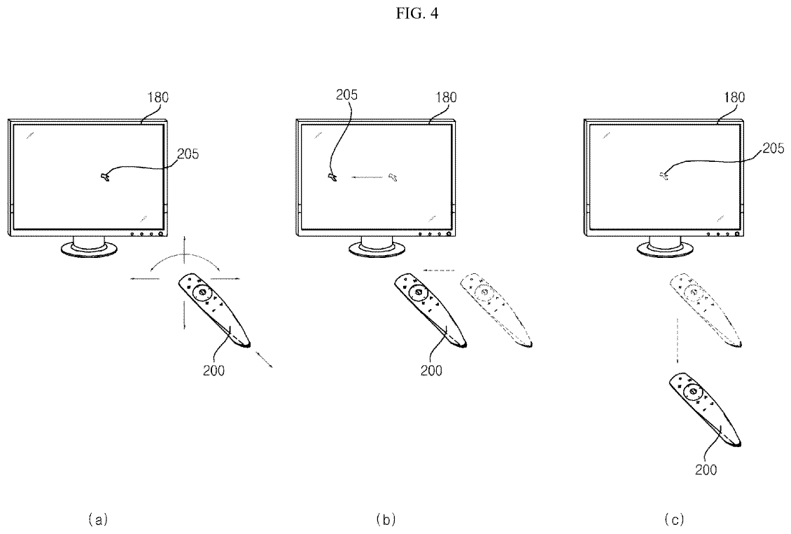

FIG. 4 illustrates a control method of a remote control device of FIG. 2.

Referring to FIG. 4, a pointer 205 corresponding to the remote control device 200 may be displayed on the display 180 of the image display device 100.

Referring to (a) of FIG. 4, a user may move the remote control device 200 up and down, left and right, and back and forth, or rotate it. The pointer 205 displayed on the display 180 of the image display device 100 may correspond to movement of the remote control device 200. As shown in the drawing, since the remote control device 200 allows the pointer 205 to be moved and displayed according to movement in a 3D space, the remote control device 200 may be referred to as a spatial remote controller or a 3D pointing device.

Referring to (b) of FIG. 4, when a user moves the remote control device 200 to the left, the pointer 205 displayed on the display 180 of the image display device 100 may move to the left in response to the movement of the remote control device 200.

Information regarding movement of the remote control device 200, which is detected through a sensor of the remote control device 200, may be transmitted to the image display device 100. The image display device 100 may calculate coordinates of the pointer 205 based on the information regarding the movement of the remote control device 200. The image display device 100 may display the pointer 205 to correspond to the calculated coordinates.

Referring to (c) of FIG. 4, a user may move the remote control device 200 away from the display 180 while pressing a specific button on the remote control device 200. Then, a selection area in the display 180 corresponding to the pointer 205 may be zoomed in and displayed in an enlarged size. By contrast, when the user moves the remote control device 200 toward the display 180 while pressing a specific button on the remote control device 200, a selection area in the display 180 corresponding to the pointer 205 may be zoomed out and displayed in a reduced size.

Meanwhile, when the remote control device 200 is moved away from the display 180, a selection area may be zoomed out, and when the remote control device 200 is moved closer to the display 180, a selection area may be zoomed in.

Meanwhile, up and down and left and right movement of the remote control device 200 may not be recognized while a specific button in the remote control device 200 is pressed. That is, when the remote control device 200 is moved away from or closer to the display 180, up, down, left and right movement of the remote control device 200 may not be recognized, and only forward and backward movement of the remote control device 200 may be recognized. While the specific button in the remote control device 200 is not pressed, only up, down, left and right movement of the remote control device 200 may be recognized, and only the pointer 205 may be moved accordingly.

Meanwhile, the moving speed or moving direction of the pointer 205 may correspond to the moving speed or moving direction of the remote control device 200.

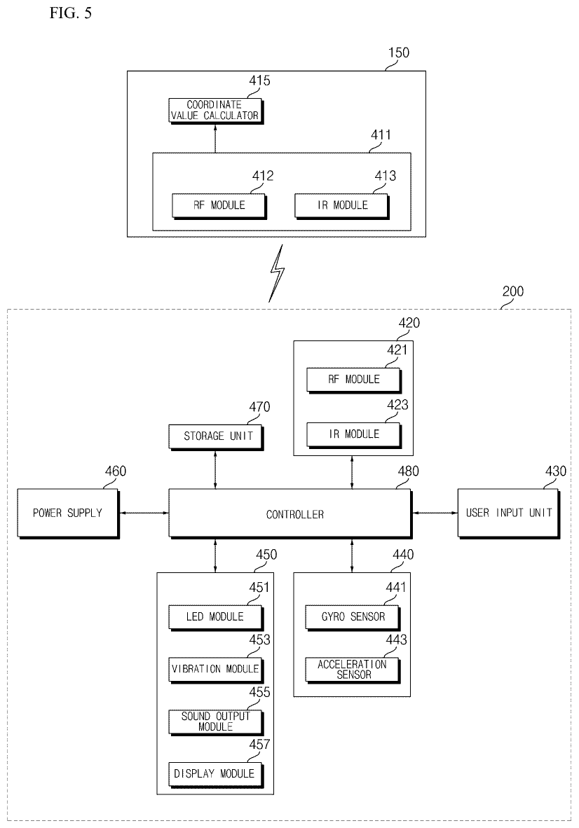

FIG. 5 is an internal block diagram of a remote control device of FIG. 2.

Referring to FIG. 5, the remote control device 200 may include a wireless communication unit 420, a user input unit 430, a sensor unit 440, an output unit 450, a power supply 460, a storage unit 470, and/or a controller 480.

The wireless communication unit 420 may transmit and receive a signal to and from the image display device 100.

In this embodiment, the remote control device 200 may include an RF module configured to transmit and receive a signal to and from the image display device 100 according to an RF communication standard. In addition, the remote control device 200 may include an IR module 423 configured to transmit and receive a signal to and from the image display device 100 according to an IR communication standard.

The remote control device 200 may transmit, through the RF module 421, a signal containing information regarding movement of the remote control device 200 to the image display device 100. The remote control device 200 may receive, through the RF module 421, a signal transmitted from the image display device 100.

The remote control device 200 may transmit, through the IR module 423, a command associated with power on/off, channel switch, volume change, or the like to the image display device 100.

The user input unit 430 may include a keypad, a button, a touch pad, a touch screen, etc. A user may manipulate the user input unit 430 to input a command associated with the image display device 100 to the remote control device 200.

When the user input unit 430 includes a hard key button, the user may input a command associated with the image display device 100 to the remote control device 200 by pushing the hard key button.

When the user input unit 430 includes a touch screen, the user may input a command associated with the image display device 100 to the remote control device 200 by touching a soft key on the touch screen.

Meanwhile, the user input unit 430 may include various types of input means, such as a scroll key, a jog key, a microphone, and the like, which can be operated by the user, and the present disclosure is not limited thereto.

The sensor unit 440 may include a gyro sensor 441 or an acceleration sensor 443. The gyro sensor 441 may sense a motion of the remote control device 200.

The gyro sensor 441 may detect information regarding the operation of the remote control device 200 based on the x, y, and z axes. The acceleration sensor 443 may detect information regarding the movement speed or the like of the remote control device 200. Meanwhile, the sensor unit 440 may further include a distance measuring sensor to detect a distance to the display 180.

The output unit 450 may output an image or audio signal corresponding to the manipulation of the user input unit 430 or corresponding to a signal transmitted from the image display device 100. The output unit 450 may allow a user to identify whether the user input unit 430 is manipulated or the image display device 100 is controlled.

The output unit 450 may include an LED module 451 to emit light, a vibration module 453 to generate vibration, a sound output module 455 to output sound, and/or a display module 457 to output an image when the user input unit 430 is manipulated or a signal is transmitted/received to/from the image display device 100 through the wireless communication unit 420.

The power supply 460 may supply power to each of the components of the remote control device 200. When the remote control device 200 is not moved for a predetermined time, the power supply 460 may cut off power supply to reduce power waste. The power supply 460 may resume the power supply when a predetermined key provided on the remote control device 200 is manipulated.

The storage unit 470 may store varies types of programs, application data, and the like necessary for the control or operation of the remote control device.

When the remote control device 200 wirelessly transmits and receives a signal to and from the image display device 100 through the RF module 421, the remote control device 200 and the image display device 200 may transmit and receive the signal through a predetermined frequency band. The controller 480 of the remote control device 200 may store, in the storage unit 470, information regarding the frequency band and the like for wireless transmitting and receiving a signal to and from the image display device 100 paired with the remote control device 200 and may read the stored information.

The controller 480 may include at least one processor to control the overall operation of the remote control device 200.

The controller 480 may transmit a signal corresponding to manipulation of a specific key of the user input unit 430 or a signal corresponding to movement of the remote control device 200 sensed by the sensor unit 440 to the image display device 100 through the wireless communication unit 420.

The user input interface 150 of the image display device 100 may include a wireless communication unit 151 to wirelessly transmit and receive a signal to and from the remote control device 200, and a coordinate value calculator 415 to calculate coordinate values of a pointer corresponding to the operation of the remote control device 200.

The user input interface 150 may wirelessly transmit and receive a signal to and from the remote control device 200 through the RF module 412. In addition, the user input interface 150 may receive, through the RF module 412, a signal transmitted by the remote control device 200 according to the IR communication standard.

The coordinate value calculator 415 may correct a hand shake or an error based on a signal corresponding to the operation of the remote control device 200 received through the wireless communication unit 151 and calculate the coordinate values (x, y) of the pointer 205 to be displayed on the display 180.

The transmission signal of the remote control device 200 input to the image display device 100 through the user input interface 150 may be transmitted to the controller 180 of the image display device 100. The controller 180 of the image display device 180 may determine information regarding the operation and key manipulation of the remote control device 200 based on the signal transmitted from the remote control device 200, and may control the image display device 100 in response thereto.

As another example, the remote control device 200 may calculate pointer coordinate values corresponding to the operation and output the same to the user input interface 150 of the image display device 100. In this case, the user input interface 150 of the image display device 100 may transmit information regarding the received pointer coordinate values to the controller 180 without a separate process of hand-shake correction or error correction.

As another example, unlike the drawing, the coordinate value calculator 415 may be provided in the controller 170, instead of the user input interface 150.

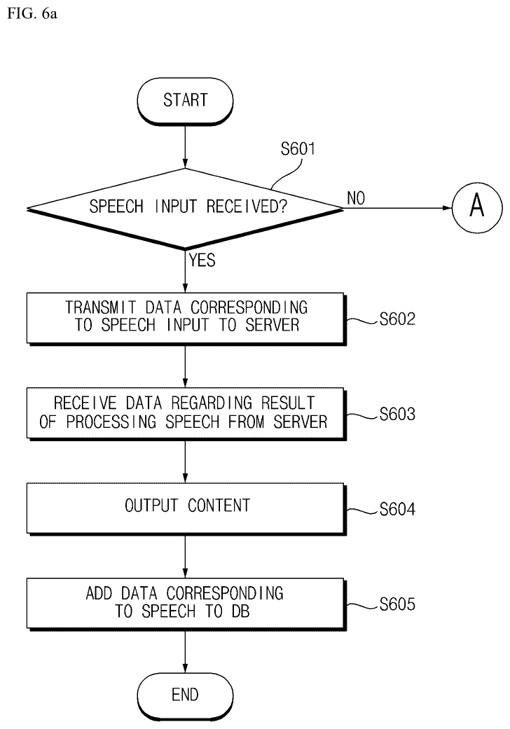

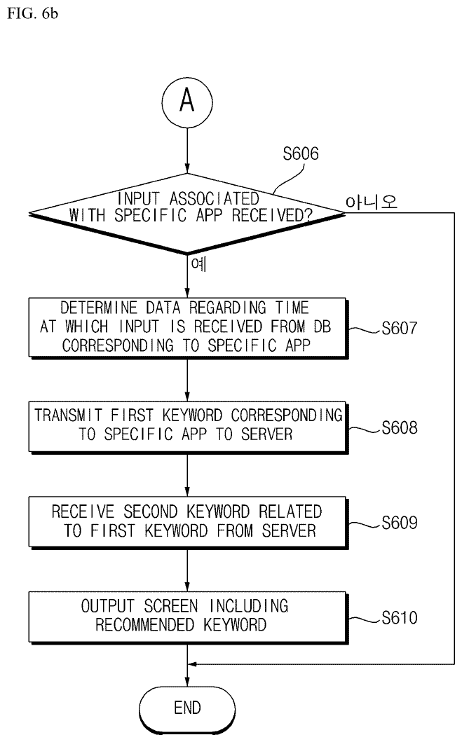

FIGS. 6A and 6B are flowcharts illustrating a method of operating an image display device according to an embodiment of the present disclosure, and FIGS. 7 to 15 are views for explaining the method of operating the image display device.

Referring to FIG. 6A, in operation S601, the image display device 100 may determine whether a voice or speech input is received. For example, the image display device 100 may receive a voice or speech input through a microphone included in the input unit 160. For example, the image display device 100 may receive a signal corresponding to a voice or speech input from the remote control device 200 through the user input interface 150.

In operation S602, in response to receiving the speech input, the image display device 100 may transmit data corresponding to the speech input to a first server through the network interface 135. For example, the image display device 100 may transmit audio data corresponding to the speech input to the first server. Here, the first server may be a server that extracts words included in the speech through speech recognition using natural language processing (NLP). In one embodiment, the first server may be configured as a plurality of servers. For example, the first server may include a speech-to-text (STT) server that converts audio data corresponding to speech input into text, and a keyword server that determines a keyword based on the converted text. In this case, the image display device 100 may receive text data corresponding to audio data from the STT server, and then may transmit the text data to the keyword server.

In operation S603, the image display device 100 may receive data regarding a result of processing the speech from an external server through the network interface 135. Here, data regarding the result of processing the speech may include at least one keyword (hereinafter referred to as an “input keyword”) corresponding to a word included in the speech. For example, when the received speech input is “Search Baby Shark on YouTube”, data regarding the result of processing the speech may include “YouTube,” “Baby Shark,” and “Search” as input keywords.

In one embodiment, data regarding the result of processing the speech may include at least one keyword (hereinafter referred to as a “related keyword”) related to a word included in the speech. The related keyword may include, among words included in the speech, the type of a target for an operation (or action) to be performed. For example, when data regarding the result of processing the speech includes “YouTube,” “Baby Shark,” and “Search”, “YouTube” may correspond to an application to be executed, “Search” may correspond to an operation to be performed on the application, and “Baby Shark” may correspond to a target of the operation. In this case, “kids” that corresponds to the type of “Baby Shark”, which is the target of the operation, may be included in the data regarding the result of processing the speech as a related keyword.

Meanwhile, it is described that data regarding the result of processing the speech is received from the first server, but the present disclosure is not limited thereto. For example, the image display device 100 may determine words included in the speech through speech recognition using natural language processing technology (NLP). For example, the image display device 100 may determine a related keyword related to words included in the speech.

In operation S604, the image display device 100 may output content through the display 180 based on the data regarding the result of processing the speech. For example, based on the data regarding the result of processing the speech including “YouTube”, which corresponds to an application to be executed, as an input keyword, the image display device 100 may execute an application corresponding to “YouTube”. In addition, based on the data regarding the result of processing the speech input including “search” that corresponds to an operation and “Baby Shark” that corresponds to a target of the operation as input keywords, the image display device 100 may output, via the display 180, a screen corresponding to a result of performing the operation of searching for “Baby Shark” on the application corresponding to “YouTube”.

In one embodiment, when the data regarding the result of processing the speech includes a specific word corresponding to an application to be executed as an input keyword, the image display device 100 may execute an application corresponding to the specific word to perform a predetermined operation. By contrast, when the data regarding the result of processing the speech does not include a specific word corresponding to an application to be executed as an input keyword, the image display device 100 may perform a predetermined operation through an application that is currently being executed.

In operation S605, the image display device 100 may add data corresponding to the speech to a database. For example, data corresponding to the speech may include at least one of an input keyword that is a target of an operation among words included in the speech and a related keyword related to a word included in the speech, and a time at which the speech input is received. For example, the storage unit 140 may store at least one database corresponding to an application. In this case, the image display device 100 may add data corresponding to the speech to the database corresponding to the application determined to correspond to the speech among the databases stored in the storage unit 140.

In one embodiment, the storage unit 140 may store at least one database corresponding to an application. Here, the image display device 100 may determine an application corresponding to the speech from among the databases stored in the storage unit 140. For example, when the data regarding the result of processing the speech includes a specific word corresponding to an application to be executed as an input keyword, an application corresponding to the specific word may be determined as an application corresponding to the speech. For example, when the data regarding the result of processing the speech does not include a specific word corresponding to an application to be executed as an input keyword, an application that is currently being executed may be determined as an application corresponding to the speech.

Referring to FIG. 6B, in operation S606, the image display device 100 may determine whether a predetermined input associated with a specific application is received. For example, the image display device 100 may determine whether a predetermined input of pressing a specific button provided on the remote control device 200 is received through the user input interface 150.

Referring to FIG. 7, the image display device 100 may output a home screen 700 including objects corresponding to a plurality of applications. For example, the home screen 700 may include at least one object corresponding to an application related to an OTT service that provides content.

In a state where the pointer 205 corresponding to the remote control device 200 is displayed on an object 710 corresponding to a specific application that provides a specific OTT service (e.g., YouTube), when a user presses a specific button included in the user input unit 430 of the remote control device 200, the image display device 100 may determine that a predetermined input associated with a specific application providing a specific OTT service has been received.

In one embodiment, based on an input received while a screen providing a specific OTT service is output via the display 180 according to execution of a specific application, the image display device 100 may determine whether a predetermined input associated with a specific application is received. For example, in a state where a screen providing a specific OTT service is output via the display 180, when a user presses a specific button included in the user input unit 430 of the remote control device 200, the image display device 100 may determine that a predetermined input associated with a specific application providing a specific OTT service has been received.

In operation S607, in response to receiving the predetermined input associated with the specific application, the image display device 100 may determine data, which corresponds to a time at which the predetermined input is received, from a database corresponding to the specific application.

The image display device 100 may determine a database corresponding to the specific application from among the databases stored in the storage unit 140. In addition, the image display device 100 may extract data corresponding to a time at which the predetermined input is received from the data included in the database corresponding to the specific application. For example, based on the time of receiving the predetermined input corresponding to 3 P.M., the image display device 100 may extract data including a time corresponding to 3 P.M. from the data included in the database corresponding to the specific application.

In operation S608, the image display device 100 may transmit a first keyword corresponding to the specific application to a second server through the network interface 135. Here, the first server and the second server may be configured as a single server (i.e., the same server) or may be configured as different servers.

In one embodiment, the image display device 100 may determine a first keyword based on the frequency of keywords included in data corresponding to a time at which a predetermined input is received. For example, the image display device 100 may determine, among input keywords that are the target of operation included in data corresponding to a time at which a predetermined input is received, a word with the highest frequency as a first keyword. In this case, the image display device 100 may also determine a word included in the database as a related keyword related to the word determined to be most frequent as the first keyword. For example, when “Baby Shark” has the highest frequency of use among the input keywords that are the target of operation included in the data, the image display device 100 may determine “Baby Shark” and “kids” that is a related keyword related to “Baby Shark” as a first keyword.

In operation S609, the image display device 100 may receive a second keyword related to the first keyword from the second server.

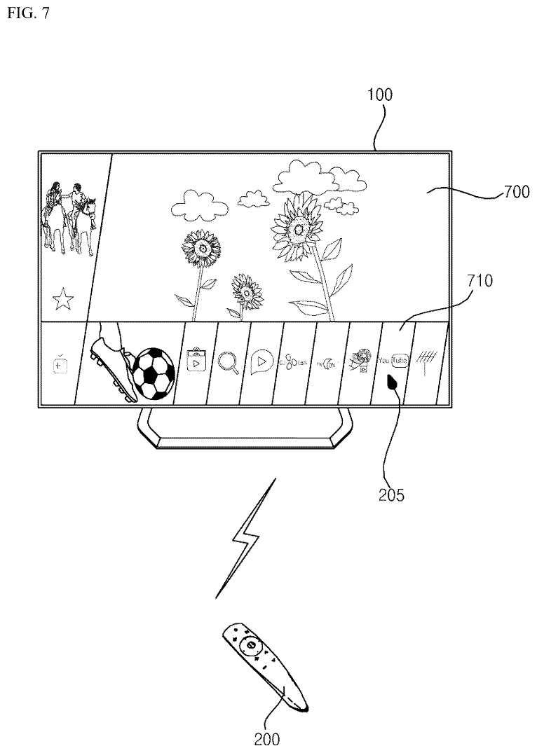

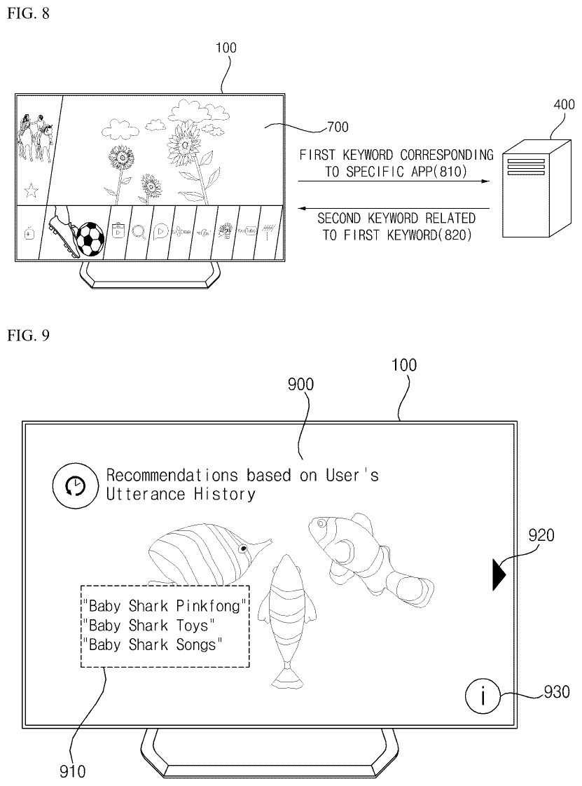

Referring to FIG. 8, based on the predetermined input associated with the specific application being received while the home screen 700 is output, the image display device 100 may transmit a first keyword corresponding to the specific application to the second server 400 (810). While the home screen 700 is output, the image display device 100 may receive a second keyword related to the first keyword from the second server 400 (820).

For example, the second server 400 may include a database for at least one word that has been uttered together with the input keyword that is a target of an operation. In this case, the second server 400 may transmit, to the image display device 100, at least one word that has been uttered together with the input keyword included in the first keyword received from the image display device 100 as the second keyword. Meanwhile, words that have been uttered together with the input keyword included in the second keyword may be determined based on the frequency of being uttered together with the input keyword.

For example, the second server 400 may include a database for content corresponding to a specific type. Here, the specific type may include a genre of content, a content provider, a broadcast channel, an application, etc. In this case, the second server 400 may transmit, to the image display device 100, at least one word that corresponds to specific content corresponding to the specific type, which is a related keyword included in the first keyword received from the image display device 100, as the second keyword. Meanwhile, a word corresponding to specific content included in the second keyword may be determined based on the playback frequency of content.

In operation S610, the image display device 100 may output, via the display 180, a screen including at least one recommended keyword corresponding to the second keyword.

In one embodiment, when at least one word that has been uttered together with the input keyword is included in the second keyword received from the second server, the image display device 100 may determine the input keyword, which is a target of an operation, and a word included in the second keyword as one recommended keyword.

In one embodiment, when the second keyword received from the second server includes at least one word that corresponds to specific content corresponding to a specific type, the image display device 100 may determine the word corresponding to the specific content as a recommended keyword.

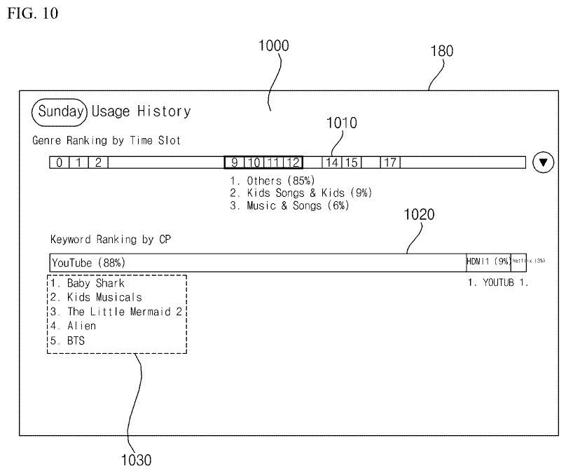

Referring to FIGS. 9 and 10, the image display device 100 may output a first screen 900 including recommended keywords corresponding to user's usage history. The first screen 900 may include at least one recommended keyword 910 corresponding to the input keyword that is a target of an operation included in the first keyword. For example, when the input keyword that is a target of an operation included in the first keyword is “Baby Shark” and words included in the second keyword are “Pinkfong,” “Toys,” and “Songs”, the image display device 100 may determine “Baby Shark Pinkfong,” “Baby Shark Toys,” and “Baby Shark Songs” as recommended keywords, respectively.

The first screen 900 may include an object 920 corresponding to the user's usage history and/or an object 930 corresponding to the next screen. When a user selects the object 920 corresponding to the user's usage history using the pointer 205 corresponding to the remote control device 200, the image display device 100 may output a screen 1000 corresponding to the user's usage history.

The screen 1000 corresponding to the user's usage history may include at least one indicator based on data included in the database stored in the storage unit 140. The screen 1000 corresponding to the user's usage history may include an indicator 1010 indicating the frequency of types of targets of operation included in user's voice or speech by time slot, an indicator 1020 indicating most frequently executed applications in response to voice or speech input in specific time slot, and a third indicator 1030 indicating most searched objects (terms) on specific application in specific time slot. Thus, the user can check an application frequently executed through a voice or speech input in a specific time slot. In addition, the user can check a frequently searched keyword related to a specific application in a specific time slot.

When the user selects one of the recommended keywords 910 corresponding to the input keyword using the pointer 205 corresponding to the remote control device 200, the image display device 100 may search the selected recommended keyword, of the recommended keywords 910, on a specific application.

Meanwhile, when the user selects the object 930 corresponding to the next screen using the pointer 205 corresponding to the remote control device 200, the image display device 100 may output a second screen 1100 including a recommended keyword corresponding to a specific type.

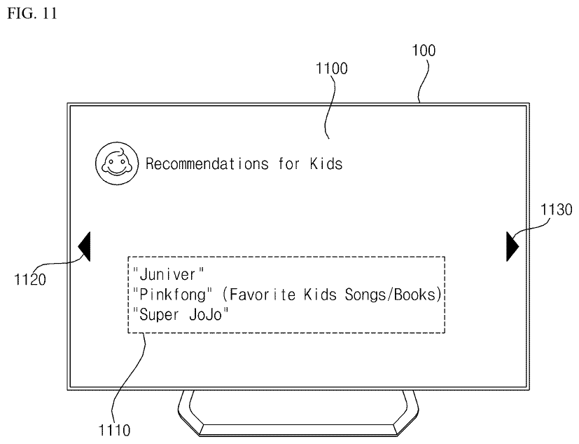

Referring to FIG. 11, the second screen 1100 may include at least one recommended keyword 1110 corresponding to a related keyword that is the type of a target of an operation included in the first keyword. For example, when a specific type of the related keyword included in the first keyword is “kids” and words included in the second keyword are “Juniver,” “Pinkfong,” and “Super JoJo”, the image display device 100 may determine “Juniver,” “Pinkfong,” and “Super JoJo” as recommended keywords, respectively.

When the user selects one of the recommended keywords 1110 corresponding to the related keyword using the pointer 205 corresponding to the remote control device 200, the image display device 100 may search the recommended keyword selected by the user on a specific application.

The second screen 1100 may include an object 1120 corresponding to the previous screen and/or an object 1130 corresponding to the next screen. When the user selects the object 1120 corresponding to the previous screen using the pointer 205 corresponding to the remote control device 200, the image display device 100 may output the first screen 900 again. Meanwhile, when the user selects the object 1130 corresponding to the next screen using the pointer 205 corresponding to the remote control device 200, the image display device 100 may output a third screen 1200 including recommended keywords corresponding to a function and an application.

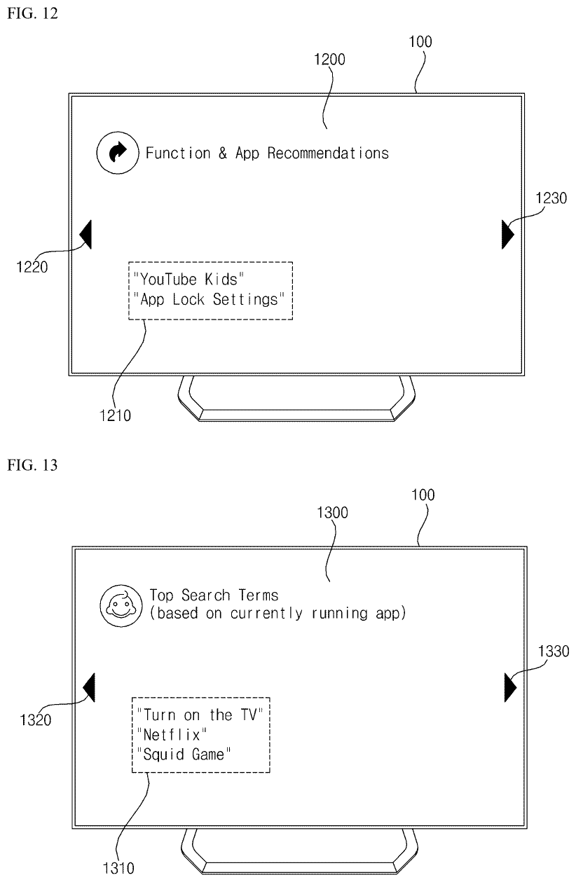

Referring to FIG. 12, the third screen 1200 may include at least one recommended keyword 1210 corresponding to an application and/or function associated with the related keyword, which is the type of a target of an operation included in the first keyword. For example, when a specific type that is the related keyword included in the first keyword is “kids,” the image display device 100 may determine an application providing an OTT service (e.g., YouTube Kids) related to “kids” as a recommended keyword.

When the user selects any one of the recommended keyword 1210 corresponding to an application and/or function using the pointer 205 corresponding to the remote control device 200, the image display device 100 may execute an application or function corresponding to the recommended keyword selected by the user.

The third screen 1200 may include an object 1220 corresponding to the previous screen and/or an object 1230 corresponding to the next screen. When the user selects the object 1220 corresponding to the previous screen using the pointer 205 corresponding to the remote control device 200, the image display device 100 may output the second screen 1100 again. Meanwhile, when the user selects the object 1230 corresponding to the next screen using the pointer 205 corresponding to the remote control device 200, the image display device 100 may output a fourth screen 1300 including a recommended keyword corresponding to a specific application.

Referring to FIG. 13, the fourth screen 1300 may include at least one recommended keyword 1310 corresponding to a specific application. For example, when the specific application is an application that provides a specific OTT service (e.g., YouTube), a search term provided by the specific OTT service (e.g., YouTube) at a time when a predetermined input is received may be determined as a recommended keyword.

When the user selects one of the recommended keywords 1310 corresponding to a specific application using the pointer 205 corresponding to the remote control device 200, the image display device 100 may search the recommended keyword selected by the user on the specific application.

The fourth screen 1300 may include an object 1320 corresponding to the previous screen and/or an object 1330 corresponding to the next screen. When the user selects the object 1320 corresponding to the previous screen using the pointer 205 corresponding to the remote control device 200, the image display device 100 may output the third screen 1200 again. Meanwhile, when the user selects the object 1330 corresponding to the next screen using the pointer 205 corresponding to the remote control device 200, the image display device 100 may output a fifth screen 1400 including a recommended keyword corresponding to another application.

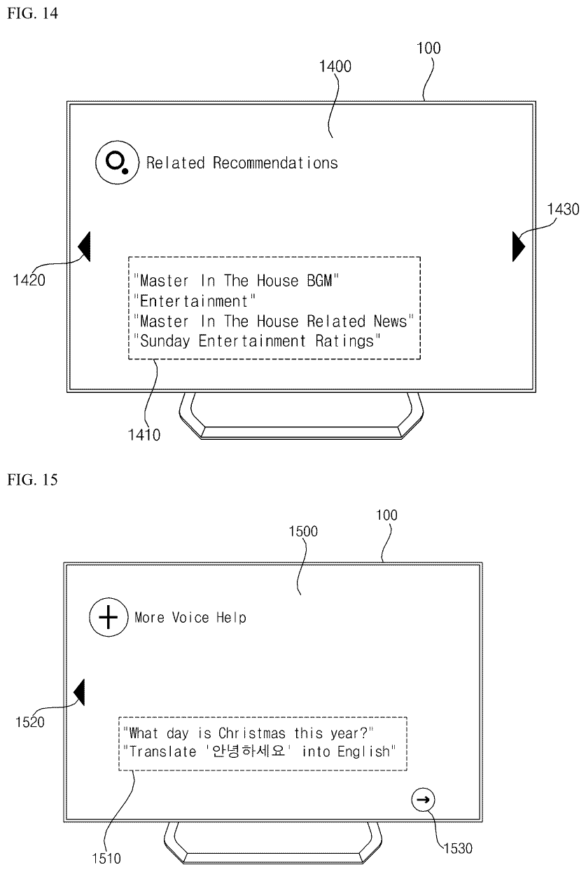

Referring to FIG. 14, the fifth screen 1400 may include at least one recommended keyword 1410 corresponding to another application. For example, when another application is an application that provides another OTT service (e.g., Netflix), a search term provided by the another OTT service (e.g., Netflix) at a time when a predetermined input is received may be determined as a recommended keyword.

When the user selects one of the recommended keywords 1410 corresponding to another application using the pointer 205 corresponding to the remote control device 200, the image display device 100 may execute the another application. In addition, the image display device 100 may search the recommended keyword selected by the user on the another application.

The fifth screen 1400 may include an object 1420 corresponding to the previous screen and/or an object 1430 corresponding to the next screen. When the user selects the object 1420 corresponding to the previous screen using the pointer 205 corresponding to the remote control device 200, the image display device 100 may output the fourth screen 1300 again. Meanwhile, when the user selects the object 1430 corresponding to the next screen using the pointer 205 corresponding to the remote control device 200, the image display device 100 may output a sixth screen 1500 including a guidance for speech input.

Referring to FIG. 15, the sixth screen 1500 may include an example 1510 of speech input, an object 1520 corresponding to the previous screen, and/or an object 1530 corresponding to a detailed view.

When the user selects the object 1520 corresponding to the previous screen using the pointer 205 corresponding to the remote control device 200, the image display device 100 may output the fifth screen 1400 again. Meanwhile, when the user selects the object 1530 corresponding to a detailed view using the pointer 205 corresponding to the remote control device 200, the image display device 100 may output all examples of speech input.

As described above, according to various embodiments of the present disclosure, keywords for content that a user is likely to prefer can be recommended more quickly and accurately, based on the user's usage history, without worrying about personal information leakage.

In addition, according to various embodiments of the present disclosure, optimized keywords can be recommended for each of a plurality of applications.

The above description should not be construed as restrictive in all aspects but considered as illustrative. The scope of the disclosure should be determined by reasonable interpretation of the appended claims and all changes that come within the equivalent scope of the disclosure are included in the scope of the disclosure.

Meanwhile, the method of operating the image display device of the present disclosure can be implemented as processor-readable code in a recording medium readable by a processor provided in the image display device. The processor-readable recording medium may be any type of recording device capable of storing data readable by a processor. Examples of the processor-readable recording medium may include a ROM, a RAM, a CD-ROM, a magnetic tape, a floppy disc, and an optical data storage device. Also, the processor-readable recording medium may be implemented as a carrier wave (e.g., data transmission over the Internet). The processor-readable recording medium may be distributed to a computer system connected via a network so that the processor-readable codes may be saved and executed in a distributed manner.

Although the preferred embodiments of the present disclosure have been illustrated and described, those skilled in the art will appreciate that the present disclosure should not be limited to the above specific embodiments and various modifications thereof are possible without departing from the scope and spirit of the disclosure as disclosed in the accompanying claims and these modifications should not be understood independently of the technical idea of the present disclosure.

1. An image display device comprising:
a display;
a network interface configured to communicate with at least one server;
a memory configured to store at least one database corresponding to an application; and
a controller,
wherein the controller is configured to:
in response to receiving a predetermined input associated with a specific application, determine, of data included in a database corresponding to the specific application, at least one piece of data corresponding to a time at which the predetermined input is received;
based on the determined at least one piece of data, transmit a first keyword corresponding to the specific application to a server through the network interface; and
based on at least one second keyword related to the first keyword being received from the sever through the network interface, output, via the display, a screen including at least one recommended keyword corresponding to the received second keyword.

2. The image display device of claim 1, further comprising a microphone,
wherein the controller is configured to:
in response to receiving speech of a user through the microphone, determine an application corresponding to the received speech; and
add data corresponding to the speech to a database corresponding to the determined application, and
wherein the data corresponding to the speech includes at least one of an input keyword corresponding to a word included in the speech and a related keyword related to the input keyword, and a time at which the speech is received.

3. The image display device of claim 2, wherein the input keyword includes a word corresponding to a target of an operation among words included in the speech, and
wherein the related keyword includes a type of the target.

4. The image display device of claim 2, wherein the controller is configured to:
based on a specific word corresponding to an application being included in the speech, determine an application corresponding to the specific word as an application corresponding to the speech; and
based on a specific word corresponding to an application not being included in the speech, determine an application that is being executed at a time when the speech is received as an application corresponding to the speech.

5. The image display device of claim 1, wherein the controller is configured to determine the first keyword based on a frequency of keywords included in the at least one piece of data corresponding to the time at which the predetermined input is received.

6. The image display device of claim 1, wherein the first keyword includes a first word corresponding to a search target,
wherein the second keyword includes at least one second word related to the first word, and
wherein the controller is configured to determine the first word and the second word as one recommended keyword.

7. The image display device of claim 1, wherein the first keyword includes a specific type of content,
wherein the second keyword includes at least one word that corresponds to specific content corresponding to the specific type, and
wherein the controller is configured to determine a word corresponding to the specific content as the recommended keyword.

8. A method of operating an image display device, the method comprising:
in response to receiving a predetermined input associated with a specific application, determining, of data included in a database corresponding to the specific application stored in a memory, at least one piece of data corresponding to a time at which the predetermined input is received;
based on the determined at least one piece of data, transmitting a first keyword corresponding to the specific application to a server; and
based on at least one second keyword related to the first keyword being received from the server, outputting, via a display, a screen including at least one recommended keyword corresponding to the received second keyword.

9. The method of claim 8, further comprising:
in response to receiving speech of a user through a microphone, determining an application corresponding to the received speech; and
adding data corresponding to the speech to a database corresponding to the determined application,
wherein the data corresponding to the speech includes at least one of an input keyword corresponding to a word included in the speech and a related keyword related to the input keyword, and a time at which the speech is received.

10. The method of claim 9, wherein the input keyword includes a word corresponding to a target of an operation among words included in the speech, and
wherein the related keyword includes a type of the target.

11. The method of claim 9, further comprising:
based on a specific word corresponding to an application being included in the speech, determining an application corresponding to the specific word as an application corresponding to the speech; and
based on a specific word corresponding to an application not being included in the speech, determining an application that is being executed at a time when the speech is received as an application corresponding to the speech.

12. The method of claim 8, wherein the transmitting of the first keyword to the server comprises determining the first keyword based on a frequency of keywords included in the at least one piece of data corresponding to the time at which the predetermined input is received.

13. The method of claim 8, wherein the first keyword includes a first word corresponding to a search target,
wherein the second keyword includes at least one second word related to the first word, and
wherein the outputting of the screen comprises determining the first word and the second word as one recommended keyword.

14. The method of claim 8, wherein the first keyword includes a specific type of content,
wherein the second keyword includes at least one word that corresponds to specific content corresponding to the specific type, and
wherein the outputting of the screen comprises determining a word corresponding to the specific content as the recommended keyword.
